(19) United States
(12) Patent Application Publication
(10) Pub. No.: US 2025/0211357 A1
(43) Pub. Date: Jun. 26, 2025

(54) SHORT WAVELENGTH DIVISION MULTIPLEXING SYSTEM

(71) Applicants: Cisco Technology, Inc., San Jose, CA (US); Politecnico di Torino, Torino (IT)

(72) Inventors: Fabrizio Forghieri, Modena (MO) (IT); Andrea Carena, Carmagnola (TO) (IT); Ann Margareth Rosa Brusin, Coazze (TO) (IT)

(21) Appl. No.: 18/394,244

(22) Filed: Dec. 22, 2023

(51) Int. Cl. H04J 14/02; H04B 10/2581

(52) U.S. Cl. CPC H04J 14/0209; H04B 10/2581

(57) ABSTRACT

In some aspects, the techniques described herein relate to a method including: providing a first optical signal of a first wavelength with a first bitrate to a multiplexer; providing a second optical signal of a second wavelength with a second bitrate to the multiplexer, wherein the first bitrate is greater than the second bitrate and the first wavelength is shorter than the second wavelength; multiplexing the first optical signal and the second optical signal to form a multiplexed signal; and transmitting the multiplexed signal via an optical fiber.

### TECHNICAL FIELD

The present disclosure relates to optical transmitters and optical transmission links.

### BACKGROUND

In Short Wavelength Division Multiplexing (SWDM) systems over multimode fibers (MMF), four co-propagating channels at different wavelengths are coupled in the fiber to increase the capacity of the optical channel. The maximum transmission distance of the optical channel is limited by a combination of modal and chromatic dispersion.

At the time of filing of this disclosure, solutions based on fixed data rate techniques simply limit the maximum reachable distance of an SWDM channel to the distance achievable by the worst performing channel. Other solutions avoid the wavelength multiplexing at the base of the SWDM approach and rely only on a single wavelength in combination with spatial multiplexing to increase capacity. In such systems, capacity is increased by including additional optical fibers which require a corresponding number of additional independent transceivers.

### BRIEF DESCRIPTION OF THE DRAWINGS

FIG. 1 is a schematic illustration of a Short Wave Division Multiplexing (SWDM) optical transmission channel configured to implement the variable rate SWDM techniques of this disclosure, according to an example embodiments.

FIGS. 2A-2D illustrate bitrate vs distance curves obtained for multimode fibers simulated in the development of the disclosed variable rate SWDM techniques, according to an example embodiment.

FIG. 3 depicts graphs providing characterizations of maximum SWDM throughput for a wide range of link distances, according to an example embodiment.

FIG. 4 depicts graphs of SWDM system maximum throughput as a function of distance when each SWDM wavelength transmits at the same bitrate versus an implementation of the disclosed variable rate SWDM techniques in which the different SWDM wavelengths transmit at different bitrates, according to an example embodiment.

FIGS. 5A-5C depict graphs illustrating maximum transmission length versus wavelength for three equalizers implementing the variable rate SWDM techniques disclosed herein, according to an example embodiment.

FIGS. 6A and 6B depict graphs summarizing SWDM system maximum reach for numerous equalizers, vertical cavity surface emitting laser vendors and fiber types, according to example embodiments.

FIG. 7 illustrates a flowchart providing a first example method for implementing the variable rate SWDM techniques of this disclosure, according to an example embodiment.

FIG. 8 illustrates a flowchart providing a second example method for implementing the variable rate SWDM techniques of this disclosure, according to an example embodiment.

FIG. 9 illustrates a functional block diagram of a computing device configured to implement the variable rate SWDM techniques of this disclosure, according to an example embodiment.

### DETAILED DESCRIPTION

### Overview

In some aspects, the techniques described herein relate to a method including: providing a first optical signal of a first wavelength with a first bitrate to a multiplexer; providing a second optical signal of a second wavelength with a second bitrate to the multiplexer, wherein the first bitrate is greater than the second bitrate and the first wavelength is shorter than the second wavelength; multiplexing the first optical signal and the second optical signal to form a multiplexed signal; and transmitting the multiplexed signal over an optical fiber.

In some aspects, the techniques described herein relate to a method including: providing a first optical signal of a first wavelength at a first bitrate; providing a second optical signal of a second wavelength at a second bitrate, wherein the second wavelength is longer than the first wavelength and the second bitrate is less than the first bitrate; providing a third optical signal of a third wavelength at a third bitrate, wherein the third wavelength is longer than the second wavelength and the third bitrate is less than the second bitrate; providing a fourth optical signal of a fourth wavelength at a fourth bitrate, wherein the fourth wavelength is longer than the third wavelength and the fourth bitrate is less than the third bitrate; multiplexing the first optical signal, the second optical signal, the third optical signal, and the fourth optical signal to form a multiplexed signal; and transmitting the multiplexed signal via an optical fiber.

In some aspects, the techniques described herein relate to an apparatus including: a plurality of vertical cavity surface emitting lasers; a multiplexer; an optical fiber; and one or more processors, wherein the one or more processors are configured to: control the plurality of vertical cavity surface emitting lasers to provide a first optical signal of a first wavelength with a first bitrate to a multiplexer; control the plurality of vertical cavity surface emitting lasers to provide a second optical signal of a second wavelength with a second bitrate to the multiplexer, wherein the first bitrate is greater than the second bitrate and the first wavelength is shorter than the second wavelength; and control the multiplexer to multiplex the first optical signal and the second optical signal to form a multiplexed signal and transmit the multiplexed signal over the optical fiber.

### Example Embodiments

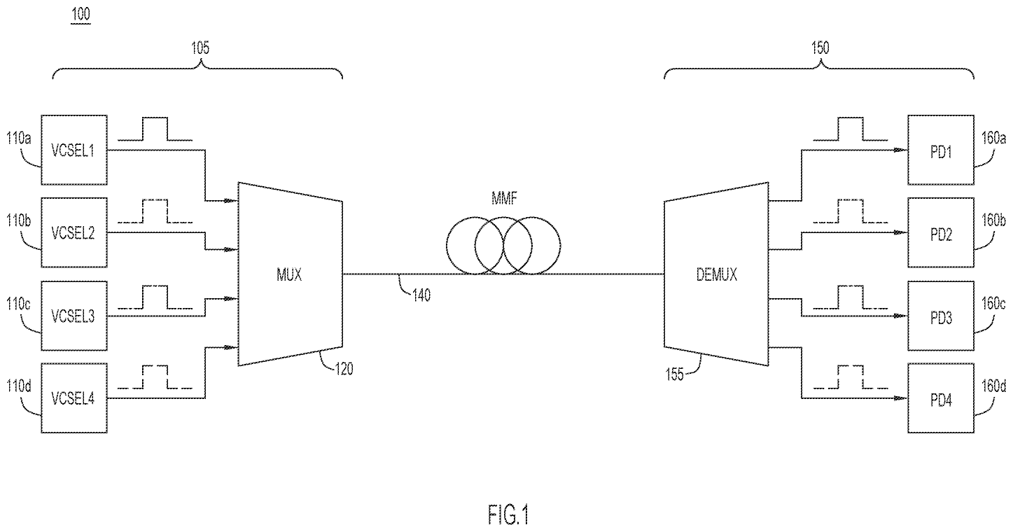

Wavelength-Division Multiplexing (WDM) provides for high-capacity optical communication systems. FIG. 1 schematically illustrates a WDM transmission system 100. At the transmitter side 105, multiple optical transmitters 110a-d each emit optical signals at a different wavelength. The signals sent by transmitters 110a-d are multiplexed by a wavelength multiplexer (MUX) 120. The multiplexed signals are then transmitted over an optical fiber 140. At the receiver side 150, the signals are de-multiplexed by a wavelength de-multiplexer (DEMUX) 155 and sent to multiple photodetector (PD) receivers 160a, 160b, 160c, and 160d.

One primary advantage of using WDM technology is reducing the number of fibers used in the main transmission line. As illustrated in FIG. 1, a single optical fiber 140 is used to transmit four signals, one from each of transmitters 110a-d. Using WDM technology, the number of fibers in an optical cable is reduced compared to spatial multiplexing techniques. For this reason, among others, WDM may be advantageous, at least from a cost and complexity perspective.

Following the ever increasing demand for throughput (e.g., links with throughputs of 100 Gbps or greater), some data center interconnects (DCI) rely on Short Wavelength Division Multiplexing (SWDM) systems for short reach links (e.g., links of hundreds of meters). SWDM is a specific WDM technology in which multimode fibers (MMFs) are coupled with transceivers based on directly modulated Vertical Cavity Surface Emitting Lasers (VCSELs). Such SWDM systems may address technical challenges, such as addressing limited opto-electronic device bandwidth, modal dispersion (MD) and chromatic dispersion (CD). Thus, when embodied as an SWDM system, optical fiber 140 of system 100 may be embodied as a multimode optical fiber.

Further, SWDM technology extends the traditional 850 nm wavelength used in multimode fibers to a range of 850 nm-940 nm, expanding the transmission wavelengths of multimode fibers. SWDM technology may multiplex four wavelengths (e.g., 850 nm, 880 nm, 910 nm, and 940 nm wavelengths) onto a single multimode fiber, allowing multiple wavelengths to be simultaneously transmitted within the same fiber. This enables the consolidation of multiple 10 Gbps or even 100 Gbps signals into a single multimode fiber, thereby increasing the transmission bandwidth. Accordingly, transmitter 110a may be configured with a VCSEL that lases at 850 nm, transmitter 110b may be configured with a VCSEL that lases at 880 nm, transmitter 110c may be configured with a VCSEL that lases at 910 nm, and transmitter 110d may be configured with a VCSEL that lases at 940 nm.

However, in such systems the maximum reach performance (i.e., the maximum achievable distance for a particular data rate) and the maximum data rate performance (i.e., the maximum achievable data rate for a particular distance) differ over the four wavelengths. Specifically, shorter wavelengths may achieve longer reach with the same bitrate, and these shorter wavelengths may also achieve higher bitrates over the same distance. Accordingly, in related art fixed rate (FR) techniques in which all wavelengths transmit data at the same bitrate for a particular distance, the maximum bitrate for any distance will be limited to the bitrate of the channel with the longest wavelength, thereby limiting the maximum reach or bitrate of the overall SWDM system. For example, in a system that utilizes wavelengths of 850 nm, 880 nm, 910 nm and 940 nm, the maximum bitrate for an any specific distance is limited by the maximum achievable bitrate for the 940 nm signal at that distance, even though the shorter wavelength signals are capable of higher bitrates. Similarly, if a particular bitrate is applied to all wavelengths, the maximum achievable distance at that bitrate will be limited to the maximum achievable distance for the 940 nm signal.

The techniques of this disclosure, in contrast to the above described FR techniques, provide for a variable rate (VR) approach for SWDM systems, such as SWDM VCSEL-MMF systems. VR techniques as described herein are variable in the sense that the bitrate transmitted via each wavelength differs, allowing for a higher overall bitrate for a particular distance, or a longer transmission distance for a desired overall bitrate. For example, in an SWDM system operating at the 850 nm, 880 nm, 910 nm and 940 nm wavelengths, the 850 nm channel will operate at a highest bitrate, the 880 nm channel will operate at a second highest bitrate, the 910 nm channel will operate at a third highest bitrate, and the 940 nm channel will operate at a lowest bitrate. Put differently, provided for herein are SWDM techniques in which the bitrates of the multiplexed signals are selected such that the shorter wavelength channels operate with higher bitrates.

Applying the disclosed techniques to system 100 of FIG. 1, transmitter 110a may be configured to transmit at a first bitrate higher than those of transmitters 110b-d, transmitter 110b may be configured to transmit at a second bitrate lower than that of transmitter 110a but higher than those of transmitter 110c and transmitter 110d, transmitter 110c may be configured to transmit at a third bitrate lower than that of transmitter 110a and transmitter 110b but higher than that of transmitter 110d, and transmitter 110d may be configured to transmit at a fourth bitrate lower than those of transmitters 110a-c.

Through the disclosed techniques, the reach or capacity of an optical link may be tuned on a wavelength-by-wavelength basis:
by varying the symbol rate of each channel;
by varying the modulation format applied to each channel;
by implementing more advanced transmission techniques, like Discrete Multi-Tone (DMT), that maximize the rate based on the channel;
through transmission by Digital Sub-Carrier Modulation (DSCM), Probabilistic Constellation Shaping (PCS) or any other methods that allow data rate manipulation;
by selecting different level of Forward Error Correcting Code (FEC) overhead; or
by a joint combination of some of the previously listed approaches.

By implementing the disclosed techniques, an equalization of the performance over the multiplexed wavelengths (i.e., the different channels) may be obtained together with a significant improvement in the system maximum reach. As discussed below, implementing the disclosed VR techniques may result in a significant increase in maximum reach, with increases of up to 33%. In particular, transmissions beyond 100 m may be demonstrated for 99% of simulated OM4 (defined in The Telecommunications Industry Association Standard No. 492-AAAD) multimode fiber links.

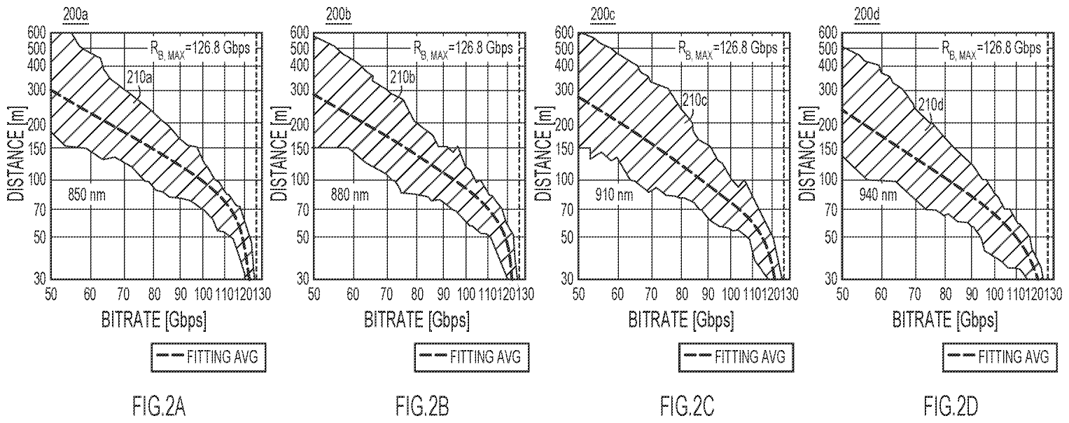

With reference now made to FIGS. 2A-D, depicted therein are bitrate vs distance graphs 200a, 200b, 200c and 200d for 850 nm, 880 nm, 910 nm and 940 nm wavelengths, respectively, which will be used to describe one example technique for determining the VR technique bitrates used in an SWDM system. As explained below, the graphs of FIGS. 2A-D were generated by simulating a variety of fiber and VCSEL combinations via a system-level numerical simulator.

Specifically, the simulations that resulted in graphs 200a, 200b, 200c and 200d were directed to a Pulse Amplitude Modulation 4-level (PAM4), four wavelength SWDM-VCSEL-MMF system in which each wavelengths transmits 100 Gbps. This system was simulated for 20,233 MMFs (16,467 OM3 fibers and 3,766 OM4 fibers) coupled with 8 VCSELs over distances up to 600 m. A soft backplane pulse amplitude modulation 4-level forward error correction code for 400 Gbps signals (KP4-FEC) with 6.25% overhead was included in the transmitted signals, resulting in a 106.25 Gbps raw bitrate, and a target bit error rate (BER) of BER_{T}=2×10⁻⁴. The four SWDM wavelengths used in the simulations were 850 nm, 880 nm, 910 nm and 940 nm, and three different equalizers, i.e., Feed Forward Equalizers (FFE), Decision Feedback Equalizers (DFE) and Maximum Likelihood Sequence Estimation Equalizers (MLSE), were considered.

A statistical analysis of the simulations was then used to evaluate the maximum reach for the different fiber and VCSEL combinations by extracting an analytical relationship between maximum reach and bitrate from the simulated data. For purposes of the statistical analysis, the maximum reach was defined as the distance guaranteed by 99% of analyzed cases. Accordingly, the 1% of worst performing VCSEL-MMF links (shortest distances) were extracted and analyzed. This process was applied independently on each wavelength, equalizer and fiber type, and resulted in 1317 and 301 cases, respectively for OM3 fibers and OM4 fibers. It is the results for these “worst case scenario” links that are illustrated in graphs 200a, 200b, 200c and 200d of FIGS. 2A-D. The system performance for these extracted cases was analyzed at different raw bitrate values, from 50 Gbps up to ˜130 Gbps. FIGS. 2A-D illustrate the related bitrate vs distance curves obtained for all wavelengths at the target BER for OM3 fibers and the MLSE equalizer, with the shaded regions 210a, 210b, 210c and 210d of graphs 200a, 200b, 200c and 200d, respectively, illustrating the envelopes within which the curves generated from the simulations fell.

For each wavelength, the data graphed within each of the shaded regions 210a, 210b, 210c and 210d was fitted with the following function:

$${log}_{10} ( {L}_{MAX} ) = mx + n + \frac{p}{x - {log}_{10} ( {R}_{B , MAX} )} . \qquad ( 1 )$$

Equation 1 represents a weighted combination of the linear behavior with the vertical asymptotic bound, represented by the maximum achievable bitrate R_{B,MAX} in back-to-back. The choice of the fitting function comes from observation, but it is also supported by the knowledge of the channels analyzed. If the vertical bound is given by the transceiver setup, the linear behavior captures the combination of modal and chromatic dispersion present in the channel. R_{B,MAX} changes with the three equalizers and is 115.7 Gbps, 121.2 Gbps and 126.8 Gbps, respectively, for FFE, DFE and MLSE equalizers. The values m, n and p are the free coefficients determined through a Mean Square Error (MSE) fitting procedure. In FIGS. 2A-D, the fitted curves are plotted as the dashed lines.

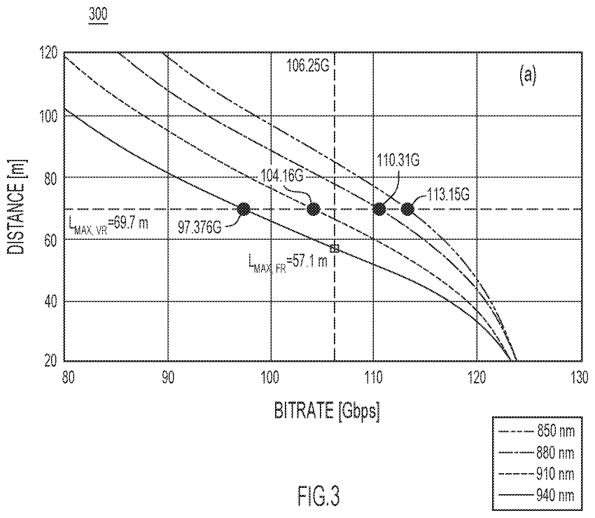

With reference now made to FIG. 3, depicted therein is a graph 300 that illustrates the results of the above-described fitting for the simulations performed on OM3 fibers using MLSE equalizers focused around the distances and bitrates most applicable to a 425 Gbps SWDM application. This graph may be used to determine how a particular channel's performance may limit the maximum achievable reach distance, as well as how to tune the channel-specific bitrates according to the disclosed VR techniques.

For example, in an FR system that transmits 400 Gbps of data with 25 Gbps of FEC overhead, each wavelength would transmit 106.25 Gbps, as 4×106.25 Gbps=425 Gbps. Cutting the fitted curves vertically at 106.25 Gbps indicates the maximum reach for all four wavelengths. The 940 nm wavelength limits the distance achievable at this bitrate to 57.1 m, as illustrated by it having the lowest distance value at the 106.25 Gbps bitrate. Cutting the fitted curves horizontally, on the other hand, illustrates how the disclosed VR techniques may tune the wavelength specific bitrates to achieve a maximum throughput for a particular reach.

Specifically, the point where the horizontal cut intercepts each graph provides the maximum bitrate achievable for a particular wavelength at the distance associated with the horizontal cut. Summing the maximum bitrates on each wavelength provides the maximum throughput of the SWDM link for that distance. For example, cutting the graphs horizontally at the 70 m distance illustrates how to tune the bitrates for the four channels to achieve the maximum throughput for a reach of 70 m. As illustrated in FIG. 3, cutting the curves horizontally at 70 m gives bitrates of 113.15 Gbps for the 850 nm wavelength, 110.31 Gbps for the 880 nm wavelength, 104.16 Gbps for the 910 nm wavelength, and 97.37 Gbps for the 940 nm wavelength. Summing these rates adds to 425 Gbps, illustrating that the disclosed VR techniques can provided improved reach when compared to FR techniques. In this specific example, the VR techniques result in 70 m of reach at 425 Gbps compared with 57.1 m of reach for the FR techniques.

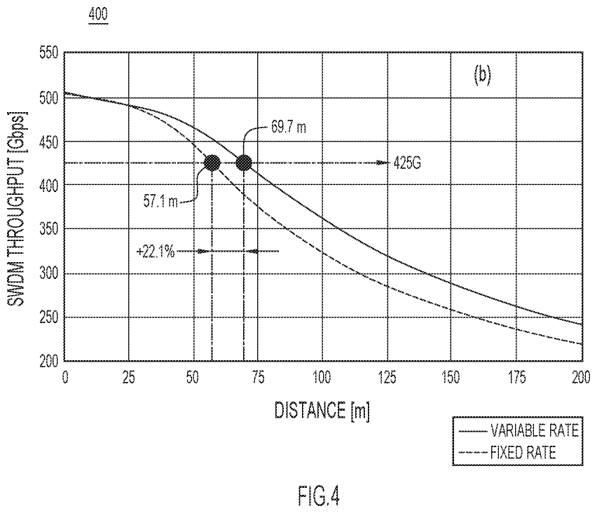

Turning to FIG. 4, FIG. 4 provides a graph 400 which shows the maximum throughput for a particular distance when each wavelength transmits at the same bitrate (the dashed line) versus an implementation of the disclosed VR techniques in which the different wavelengths transmit at different bitrates (the solid line). As illustrated in graph 400, the two techniques provide similar behavior at lower distances. However, as the distances increase, the disclosed VR techniques provided increased maximum throughput compared with FR techniques. In this specific example, an estimated increase of 22% in maximum reach (from 57.1 m to 69.7 m) of the SWDM channel at 425 Gbps is observed when the disclosed VR techniques are considered against FR techniques.

FIG. 4 also provides a comprehensive characterization of maximum SWDM throughput for a wide range of link distances, which generally provide a clear advantage to using the disclosed VR techniques compared to FR techniques. The same analysis described above for OM3 fibers can be performed for OM4 fibers with analogous results. This analysis can also be performed for different VCSEL vendors, fiber types, equalizers and channel wavelengths with analogous results.

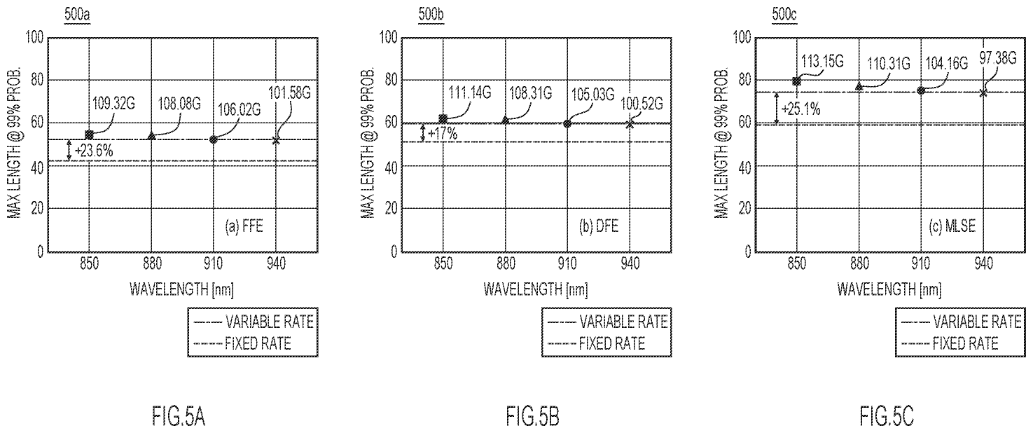

For example, with reference now made to FIGS. 5A-5C, illustrated therein are graphs 500a, 500b and 500c which graph maximum length versus wavelength for three equalizers used in conjunction with OM3 fibers. Performance of single wavelengths with the corresponding different raw bitrates are shown in each graph. The graphs illustrate an equalization on distances achieved by each wavelength. As expected from the discussion above, improved maximum reaches are possible when the disclosed VR techniques are applied, with increments of 23.6%, 17% and 25.1% for FFE, DFE and MLSE equalizers, respectively.

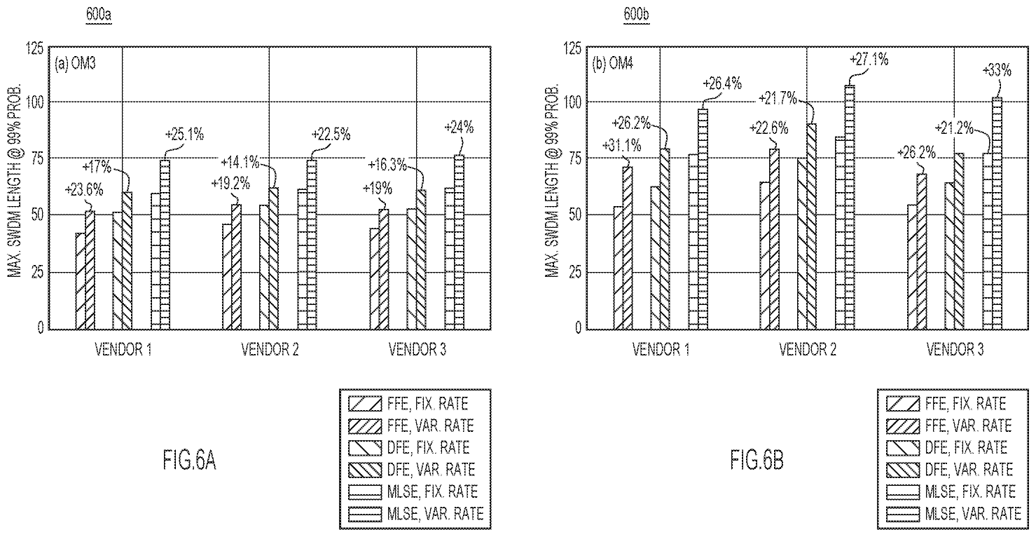

A maximum reach analysis was also performed on the simulated fibers using the related art FR techniques and the VR techniques of this disclosure. The charts 600a and 600b of FIGS. 6A and 6B, respectively, summarize the resulting SWDM system maximum reach for all equalizers, VCSEL vendors and fiber types, comparing the performance of the related art FR techniques and the disclosed VR techniques.

For both OM3 and OM4 fibers, the hierarchy of equalizers' performance was determined for all VCSEL vendors. As illustrated in FIGS. 6A and 6B, by implementing the disclosed VR techniques, all vendor VCSELs achieved ˜75 m of reach with 99% probability using MLSE equalizers over OM3 fibers, with more than 20% reach increase compared to FR techniques. Using OM4 fibers and MLSE equalizers, transmissions above 100 m are possible employing VCSELs produced by Vendor 2 and Vendor 3. Only Vendor 1 falls short by a few meters. These results show that with the VCSEL technology available at the time of this disclosure, 100 m distances may be achieved by SWDM systems carrying 425 Gbps (400 Gbps net the FEC data) transmission rates.

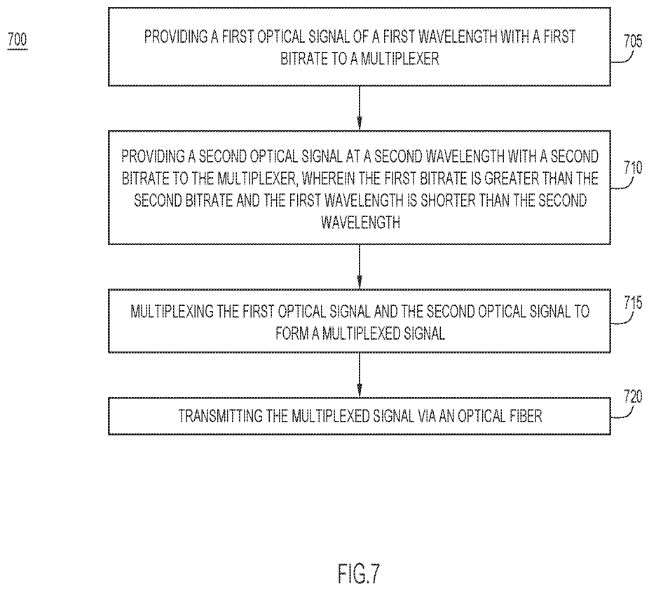

Turning to FIG. 7, depicted therein is a flowchart 700 providing a first example method for implementing the SWDM techniques of this disclosure. Flowchart 700 begins in operation 705 in which a first optical signal is provided at a first wavelength with a first bitrate. Operation 710 provides a second optical signal at a second wavelength with a second bitrate such that the first wavelength is shorter than the second wavelength and the first bitrate is greater than the second bitrate. When implemented in a SWDM system using wavelengths of 850 nm, 880 nm, 910 nm, and 940 nm as the central wavelengths of the transmission channels, the first optical signal may be embodied as the signal sent at 850 nm, 880 nm, or 910 nm. The second optical signal may be embodied as the signal sent at 880 nm, 910 nm, or 940 nm, so long as its wavelength is longer than that of the first optical signal and its bitrate is lower than that of the first optical signal. By structuring the wavelengths and bitrates as indicated in operations 705 and 710, the method of flowchart 700 implements the techniques that allow for increased bitrates and/or increased distances using SWDM techniques. As also described above, the first and second optical signals may be provided using VCSELs.

In operation 715, the first optical signal and the second optical signal are multiplexed to form a multiplexed signal. While operation 715 recites the multiplexing of two signals, implementations of operation 715 may include multiplexing additional signals, such as multiplexing three, four or more optical signals. As described above, SWDM techniques generally multiplex four signals using wavelengths of 850 nm, 880 nm, 910 nm, and 940 nm as the central wavelengths of the transmission channels. Accordingly, specific implementations of operation 715 may multiplex four such optical signals.

Finally, the multiplexed optical signal is transmitted via an optical fiber in operation 720. As described above, the optical fiber used in SWDM techniques may be a multimode fiber, such as an OM3 or OM4 optical fiber. As also described above, the techniques disclosed herein provide the ability to transmit up to and beyond 100 m. Accordingly, in implementations of operation 720, the optical fiber may be embodied as an OM3 or OM4 optical fiber that is 100 m or longer.

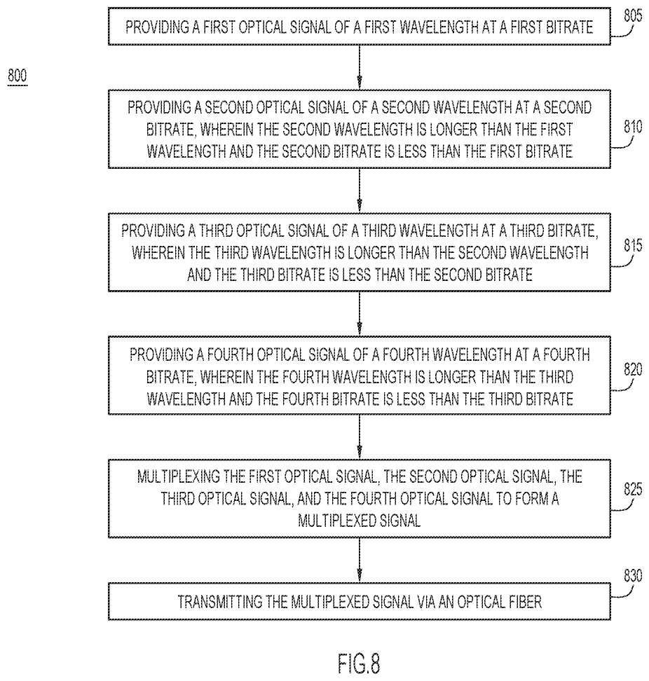

With reference now made to FIG. 8, depicted therein is a flowchart 800 providing a second example method for implementing the WDM techniques of this disclosure. Flowchart 800 recognizes that the techniques of this disclosure may have particular applicability to SWDM systems that utilize four optical channels. Accordingly, flowchart 800 begins with operations 805, 810, 815 and 820, in which first, second, third and fourth optical signals are provided, respectively. As indicated in these operations, the second optical signal has a longer wavelength and a lower bitrate than the first optical signal, the third optical signal has a longer wavelength and a lower bitrate than the second optical signal, and the fourth optical signal has a longer wavelength and a lower bitrate than the third optical signal. Accordingly, flowchart 800 implements a system in which there is an inverse relationship between wavelength and bitrate for the four optical channels. As explained above, such a system allows for increased reach or distance for an optical link and/or an increased overall bitrate for the link.

In operation 825, the first, second, third and fourth optical signals are multiplexed to form a multiplexed signal. As described above, such a multiplexed signal formed from four optical channels may have a combined bitrate of 400 Gbps or greater.

Finally, the multiplexed optical signal is transmitted via an optical fiber in operation 830. As described above, the optical fiber used in SWDM techniques may be a multimode fiber, such as an OM3 or OM4 optical fiber. As also described above, the techniques disclosed herein provide the ability to transmit up to and beyond 100 m. Accordingly, in implementations of operation 830, the optical fiber may be embodied as an OM3 or OM4 optical fiber that is 100 m or longer.

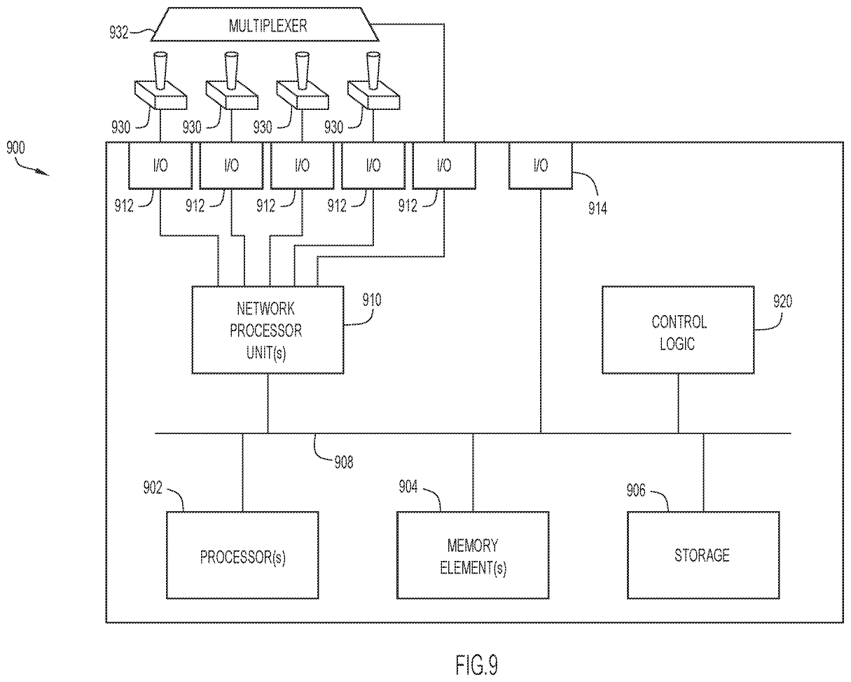

Turning to FIG. 9, depicted therein is an apparatus configured to implement the SWDM techniques of this disclosure. Specifically, FIG. 9 illustrates a hardware block diagram of a computing device 900 that may perform functions associated with operations discussed herein in connection with the techniques depicted in FIGS. 1, 2A-2D, 3, 4, 5A-C, 6A-B, 7 and 8. In various embodiments, a computing device or apparatus, such as computing device 900 or any combination of computing devices 900, may be configured as any entity/entities as discussed for the techniques depicted in connection with FIGS. 1, 2A-2D, 3, 4, 5A-C, 6A-B, 7 and 8 in order to perform operations of the various techniques discussed herein. For example, computing device 900 may be embodied as an optical transceiver configured to implement the VR techniques disclosed herein. Computing device 900 may also be embodied as a computing device that incorporates an optical transceiver configured to implement the VR techniques disclosed herein.

In at least one embodiment, the computing device 900 may be any apparatus that may include one or more processor(s) 902, one or more memory element(s) 904, storage 906, a bus 908, one or more network processor unit(s) 910 interconnected with one or more network input/output (I/O) interface(s) 912, one or more I/O interface(s) 914, and control logic 920. In various embodiments, instructions associated with logic for computing device 900 can overlap in any manner and are not limited to the specific allocation of instructions and/or operations described herein.

In at least one embodiment, processor(s) 902 is/are at least one hardware processor configured to execute various tasks, operations and/or functions for computing device 900 as described herein according to software and/or instructions configured for computing device 900. Processor(s) 902 (e.g., a hardware processor) can execute any type of instructions associated with data to achieve the operations detailed herein. In one example, processor(s) 902 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 904 and/or storage 906 is/are configured to store data, information, software, and/or instructions associated with computing device 900, and/or logic configured for memory element(s) 904 and/or storage 906. For example, any logic described herein (e.g., control logic 920) can, in various embodiments, be stored for computing device 900 using any combination of memory element(s) 904 and/or storage 906. Note that in some embodiments, storage 906 can be consolidated with memory element(s) 904 (or vice versa), or can overlap/exist in any other suitable manner.

In at least one embodiment, bus 908 can be configured as an interface that enables one or more elements of computing device 900 to communicate in order to exchange information and/or data. Bus 908 can be implemented with any architecture designed for passing control, data and/or information between processors, memory elements/storage, peripheral devices, and/or any other hardware and/or software components that may be configured for computing device 900. In at least one embodiment, bus 908 may be implemented as a fast kernel-hosted interconnect, potentially using shared memory between processes (e.g., logic), which can enable efficient communication paths between the processes.

In various embodiments, network processor unit(s) 910 may enable communication between computing device 900 and other systems, entities, etc., via network I/O interface(s) 912 (wired and/or wireless) to facilitate operations discussed for various embodiments described herein. In various embodiments, network processor unit(s) 910 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 900 and other systems, entities, etc. to facilitate operations for various embodiments described herein. In various embodiments, network I/O interface(s) 912 can be configured as one or more Ethernet port(s), Fibre Channel ports, any other I/O port(s), and/or antenna(s)/antenna array(s) now known or hereafter developed. Thus, the network processor unit(s) 910 and/or network I/O interface(s) 912 may include suitable interfaces for receiving, transmitting, and/or otherwise communicating data and/or information in a network environment. According to examples of the techniques disclosed herein, I/O interface(s) 912 communicate with VCSELs 930 and multiplexer 932, allowing computing device 900 to carry out operations as described above with reference to FIGS. 1, 2A-2D, 3, 4, 5A-C, 6A-B, 7 and 8. Specifically, processor (2) 902 may be configured to control VCSELs 930 and multiplexer 932 to carry out the WDM techniques of this disclosure.

According to other examples, multiplexer 932 may be implemented through a passive device. In such examples, multiplexer 932 may not be connected to any of I/O interface(s) 912. Instead, multiplexer 932 would passively receive the optical signals from VCSELs 930.

According to still other examples, VCSELs 930 and multiplexer 932 may be incorporated in an optical transceiver that connects to computing device 900 via one or more of I/O interface(s) 912.

I/O interface(s) 914 allow for input and output of data and/or information with other entities that may be connected to computing device 900. For example, I/O interface(s) 914 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 920 can include instructions that, when executed, cause processor(s) 902 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 920) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 904 and/or storage 906 can store data, software, code, instructions (e.g., processor instructions), logic, parameters, combinations thereof, and/or the like used for operations described herein. This includes memory element(s) 904 and/or storage 906 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

In summary, the techniques described herein relate to a method including: providing a first optical signal of a first wavelength with a first bitrate to a multiplexer; providing a second optical signal of a second wavelength with a second bitrate to the multiplexer, wherein the first bitrate is greater than the second bitrate and the first wavelength is shorter than the second wavelength; multiplexing the first optical signal and the second optical signal to form a multiplexed signal; and transmitting the multiplexed signal over an optical fiber.

In some aspects, the techniques described herein relate to a method, wherein the first wavelength is less than 940 nm and the second wavelength is greater than 910 nm.

In some aspects, the techniques described herein relate to a method, wherein the optical fiber includes a multimode optical fiber.

In some aspects, the techniques described herein relate to a method, wherein the multimode optical fiber includes an OM3 or OM4 optical fiber.

In some aspects, the techniques described herein relate to a method, wherein multiplexing the first optical signal and the second optical signal includes performing wavelength division multiplexing.

In some aspects, the techniques described herein relate to a method, wherein a central wavelength of the first wavelength is selected from the group consisting of 850 nm, 880 nm, and 910 nm.

In some aspects, the techniques described herein relate to a method, wherein a central wavelength of the second wavelength is selected from the group consisting of 880 nm, 910 nm, and 940 nm.

In some aspects, the techniques described herein relate to a method, wherein providing the first optical signal includes providing the first optical signal via a first vertical cavity surface emitting laser; and wherein providing the second optical signal includes providing the second optical signal via a second vertical cavity surface emitting laser.

In some aspects, the techniques described herein relate to a method including: providing a first optical signal of a first wavelength at a first bitrate; providing a second optical signal of a second wavelength at a second bitrate, wherein the second wavelength is longer than the first wavelength and the second bitrate is less than the first bitrate; providing a third optical signal of a third wavelength at a third bitrate, wherein the third wavelength is longer than the second wavelength and the third bitrate is less than the second bitrate; providing a fourth optical signal of a fourth wavelength at a fourth bitrate, wherein the fourth wavelength is longer than the third wavelength and the fourth bitrate is less than the third bitrate; multiplexing the first optical signal, the second optical signal, the third optical signal, and the fourth optical signal to form a multiplexed signal; and transmitting the multiplexed signal via an optical fiber.

In some aspects, the techniques described herein relate to a method, wherein a sum of the first bitrate, the second bitrate, the third bitrate and the fourth bitrate is greater than or equal to 400 Gbps.

In some aspects, the techniques described herein relate to a method, wherein multiplexing to form the multiplexed signal includes performing short wavelength division multiplexing.

In some aspects, the techniques described herein relate to a method, wherein providing the first optical signal includes providing the first optical signal with a first central wavelength of 850 nm; wherein providing the second optical signal includes providing the second optical signal with a second central wavelength of 880 nm; wherein providing the third optical signal includes providing the third optical signal with a third central wavelength of 910 nm; and wherein providing the fourth optical signal includes providing the fourth optical signal with a fourth central wavelength of 940 nm.

In some aspects, the techniques described herein relate to a method, wherein the optical fiber includes a multimode optical fiber.

In some aspects, the techniques described herein relate to a method, wherein the multimode optical fiber is 100 m or longer.

In some aspects, the techniques described herein relate to an apparatus including: a plurality of vertical cavity surface emitting lasers; a multiplexer; an optical fiber; and one or more processors, wherein the one or more processors are configured to: control the plurality of vertical cavity surface emitting lasers to provide a first optical signal of a first wavelength with a first bitrate to a multiplexer; control the plurality of vertical cavity surface emitting lasers to provide a second optical signal of a second wavelength with a second bitrate to the multiplexer, wherein the first bitrate is greater than the second bitrate and the first wavelength is shorter than the second wavelength; and control the multiplexer to multiplex the first optical signal and the second optical signal to form a multiplexed signal and transmit the multiplexed signal over the optical fiber.

In some aspects, the techniques described herein relate to an apparatus, wherein the optical fiber includes a multimode optical fiber.

In some aspects, the techniques described herein relate to an apparatus, wherein the multimode optical fiber includes an OM3 or OM4 optical fiber.

In some aspects, the techniques described herein relate to an apparatus, the multiplexer is configured to multiplex the first optical signal and the second optical signal using short wavelength division multiplexing.

In some aspects, the techniques described herein relate to an apparatus, wherein a central wavelength of the first optical signal is selected from the group consisting of 850 nm, 880 nm, and 910 nm.

In some aspects, the techniques described herein relate to an apparatus, wherein a central wavelength of the second optical signal is selected from the group consisting of 880 nm, 910 nm, and 940 nm.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
providing a first optical signal of a first wavelength with a first bitrate to a multiplexer;
providing a second optical signal of a second wavelength with a second bitrate to the multiplexer, wherein the first bitrate is greater than the second bitrate and the first wavelength is shorter than the second wavelength;
multiplexing the first optical signal and the second optical signal to form a multiplexed signal; and
transmitting the multiplexed signal via an optical fiber.

2. The method of claim 1, wherein the first wavelength is less than 940 nm and the second wavelength is greater than 910 nm.

3. The method of claim 1, wherein the optical fiber comprises a multimode optical fiber.

4. The method of claim 3, wherein the multimode optical fiber comprises an OM3 or OM4 optical fiber.

5. The method of claim 1, wherein multiplexing the first optical signal and the second optical signal comprises performing wavelength division multiplexing.

6. The method of claim 1, wherein a central wavelength of the first wavelength is selected from the group consisting of 850 nm, 880 nm, and 910 nm.

7. The method of claim 1, wherein a central wavelength of the second wavelength is selected from the group consisting of 880 nm, 910 nm, and 940 nm.

8. The method of claim 1, wherein providing the first optical signal comprises providing the first optical signal via a first vertical cavity surface emitting laser; and
wherein providing the second optical signal comprises providing the second optical signal via a second vertical cavity surface emitting laser.

9. A method comprising:
providing a first optical signal of a first wavelength at a first bitrate;
providing a second optical signal of a second wavelength at a second bitrate, wherein the second wavelength is longer than the first wavelength and the second bitrate is less than the first bitrate;
providing a third optical signal of a third wavelength at a third bitrate, wherein the third wavelength is longer than the second wavelength and the third bitrate is less than the second bitrate;
providing a fourth optical signal of a fourth wavelength at a fourth bitrate, wherein the fourth wavelength is longer than the third wavelength and the fourth bitrate is less than the third bitrate;
multiplexing the first optical signal, the second optical signal, the third optical signal, and the fourth optical signal to form a multiplexed signal; and
transmitting the multiplexed signal via an optical fiber.

10. The method of claim 9, wherein a sum of the first bitrate, the second bitrate, the third bitrate and the fourth bitrate is greater than or equal to 400 Gbps.

11. The method of claim 9, wherein multiplexing to form the multiplexed signal comprises performing short wavelength division multiplexing.

12. The method of claim 9, wherein providing the first optical signal comprises providing the first optical signal with a first central wavelength of 850 nm;
wherein providing the second optical signal comprises providing the second optical signal with a second central wavelength of 880 nm;
wherein providing the third optical signal comprises providing the third optical signal with a third central wavelength of 910 nm; and
wherein providing the fourth optical signal comprises providing the fourth optical signal with a fourth central wavelength of 940 nm.

13. The method of claim 9, wherein the optical fiber comprises a multimode optical fiber.

14. The method of claim 13, wherein the multimode optical fiber is 100 m or longer.

15. An apparatus comprising:
a plurality of vertical cavity surface emitting lasers;
a multiplexer;
an optical fiber; and
one or more processors, wherein the one or more processors are configured to:
control the plurality of vertical cavity surface emitting lasers to provide a first optical signal of a first wavelength with a first bitrate to a multiplexer;
control the plurality of vertical cavity surface emitting lasers to provide a second optical signal of a second wavelength with a second bitrate to the multiplexer, wherein the first bitrate is greater than the second bitrate and the first wavelength is shorter than the second wavelength; and
control the multiplexer to multiplex the first optical signal and the second optical signal to form a multiplexed signal and transmit the multiplexed signal over the optical fiber.

16. The apparatus of claim 15, wherein the optical fiber comprises a multimode optical fiber.

17. The apparatus of claim 16, wherein the multimode optical fiber comprises an OM3 or OM4 optical fiber.

18. The apparatus of claim 15, the multiplexer is configured to multiplex the first optical signal and the second optical signal using short wavelength division multiplexing.

19. The apparatus of claim 15, wherein a central wavelength of the first optical signal is selected from the group consisting of 850 nm, 880 nm, and 910 nm.

20. The apparatus of claim 15, wherein a central wavelength of the second optical signal is selected from the group consisting of 880 nm, 910 nm, and 940 nm.
